(19) United States
(12) Patent Application Publication
(10) Pub. No.: US 2017/0358928 A1
(43) Pub. Date: Dec. 14, 2017

(54) METHOD FOR OPTIMISING THE GENERATION OF ELECTRICAL POWER IN A NETWORK FOR GENERATING AND DISTRIBUTING ELECTRICAL POWER

(71) Applicant: Schneider Electric Industries SAS, Rueil Malmaison (FR)

(72) Inventors: Jean WILD, Coublevie (FR); Yann Herriot, Voiron (FR); Pascal Reymond, Voreppe (FR); Jean-Francois Riutort, Barraux (FR); Caroline Guyon-Aubert, Crolles (FR); Rodolphe Heliot, St Martin Le Vinoux (FR); Aurelien Havel, St Crepin et Carlucet (FR)

(73) Assignee: Schneider Electric Industries SAS, Rueil Malmaison (FR)

(21) Appl. No.: 15/601,429

(22) Filed: May 22, 2017

(30) Foreign Application Priority Data
Jun. 10, 2016 (FR) 16 55397

(51) Int. Cl. H02J 3/46; G05B 19/418; H02J 3/38

(52) U.S. Cl. CPC H02J 3/46; H02J 3/386; G05B 19/41885; H02J 3/383; G05B 2219/2639

(57) ABSTRACT

A method for generating power in a network including a non-intermittent source and an intermittent source, including predicting a demand by a load and an uncertainty; distributing a power to be generated between the sources, the distributing being suitable for minimizing a fuel consumption required for the generation by the non-intermittent source and the intermittent source; and dimensioning a reserve of power, the dimensioning being suitable for compensating for the consumption uncertainty.

### TECHNICAL FIELD

The field of the invention is that of microgrids for generating and distributing electrical power. More particularly, the invention relates to a method for controlling the generation of electrical power in a network for generating and distributing electrical power.

### PRIOR ART

A microgrid is generally a local electrical network intended to generate and distribute electrical power in regions isolated and distant from the large centres for generating electrical power. The isolated regions are, for example, islands, mountainous regions, or desert regions. The microgrid principle also applies when a building, neighbourhood, campus or other entity connected to a large distribution network wishes to manage its own generation of power otherwise and to increase its stability.

The main advantages of microgrids are that they can function autonomously (in island mode, without connection to the public network), and that they are situated close to the consumption areas (the loads).

The inherent losses of long distance distribution networks are thereby limited and access to power becomes possible when no distribution network exists.

The power autonomy of the microgrid is generally ensured by different types of sources of electricity, among which power generators occupy an important place. In fact, from an economic viewpoint, a power generator represents a low initial investment, and ensures electricity generation that is sufficiently flexible to absorb peak consumption at peak times. However, their operation requires large quantities of fuel (diesel, for example), which consequently weighs on the power bill, dependence, but also increases atmospheric pollution.

In order to remedy these economic and environmental problems, microgrids are becoming hybrid, and also comprise renewable sources of electricity such as photovoltaic or wind turbine sources of electricity, but also systems for storing electrical power. Systems for storing electrical power are generally suitable for storing electrical power once the renewable sources of electricity generate too much electricity, and for delivering the stored electrical power in the contrary case.

However, managing the generation of electricity remains highly reactive, such that it is very difficult to control the fuel consumption of power generators.

In this respect, a power generator supplies additional electrical power (increase of the load, i.e.: the current that is injected into the network by said power generator increases) once a decrease in the electrical power generated by a renewable source of electricity is observed. This decrease can be long-lasting and, without the intervention of the power generator, can generate instability of the network for generating and distributing electricity. However, such a decrease may be only temporary (for example, associated with the temporary passage of a cloud in front of a photovoltaic panel) such that the intervention of the power storage system could have compensated for it.

Consequently, the consumption of fuel by the power generators connected to the microgrid remains significant.

Methods furthermore exist that are intended to predict the levels of generation and consumption of electrical power of the networks. However, these methods have a degree of uncertainty such that it is difficult to guarantee the stability of the network (stability of the network means balance between the electrical power consumed and the electrical power generated).

An aim of the present invention is therefore to propose a method for optimising the generation of electricity that ensures the stability of the network.

Another aim of the present invention is to propose a method for optimising the generation of electricity that allows the best possible control of the consumption of fuel by the power generators connected to the microgrid, and that is easily implemented on a pre-existing microgrid.

### DESCRIPTION OF THE INVENTION

The aim of the invention is resolved by a method for controlling the generation of electrical power in a network for generating and distributing electrical power, the network comprising at least one non-intermittent generation source and at least one intermittent generation source, the method comprising:

a. a step of predicting a demand for consumption of electrical power by at least one load, connected to the network, during a given first time period, said prediction of the demand for consumption being determined with a consumption uncertainty;

c. a step of distributing, during the first time period, between the at least one non-intermittent generation source and the at least one intermittent generation source of an electrical power to be generated, the electrical power to be generated that fulfils the demand for consumption predicted at step a., the distributing step being suitable for minimizing a fuel consumption required for the generation of the electrical power to be generated by the at least one non-intermittent generation source and the at least one intermittent generation source;

the method furthermore comprising a step d. of dimensioning a reserve of electrical power immediately available during the first time period, the dimensioning being suitable for compensating, at least in part, for the consumption uncertainty and/or the generation uncertainty.

According to an embodiment, the reserve of electrical power is ensured by a non-intermittent generation source chosen between the at least one non-intermittent generation source and/or a power storage system also connected to the network.

According to an embodiment, the method furthermore comprises a step b. of predicting a capacity for generating electrical power, during the first time period, of the at least one non-intermittent generation source and of the at least one intermittent generation source, said prediction of electrical power generation being determined with a generation uncertainty, advantageously, the step d. being suitable for the reserve of electrical power to compensate also for the generation uncertainty.

According to an embodiment, the step b. comprises modelling, as mathematical equations, the capacity for generating electrical power of each of the at least one non-intermittent generation source and at least one intermittent generation source as a function of physical parameters, the physical parameters being physical values influencing the capacity for generating electrical power of each of the at least one non-intermittent generation source and at least one intermittent generation source.

According to an embodiment, the physical parameters influencing the capacity for generating electrical power of the at least one intermittent generation source comprise the meteorological forecasts during the first time period, advantageously the sunlight and/or wind speed during the first time period.

According to an embodiment, the control method is executed twenty-four hours before the start of the first period, the control method is advantageously executed at regularly spaced time intervals so as to take account of a change of the prediction, according to step b., of the capacity for generating electrical power of the at least one non-intermittent generation source and of the at least one intermittent generation source.

According to an embodiment, an additional non-intermittent generation source is started up as soon as the dimensioning of the reserve of electrical power immediately available during the first time period is insufficient to compensate, at least in part, for the consumption and/or generation uncertainty.

According to an embodiment, the step a. of predicting the demand for consumption of electrical power by the at least one load during a first time period is equal to an electrical power consumed by said at least one load forty-eight hours before the start of the given first time period t, for a duration equal to the first time period.

According to an embodiment, the at least one intermittent generation source is a renewable power generation source, the renewable power generation source advantageously comprises at least one source selected between: a photovoltaic source of electricity, a wind turbine source of electricity.

According to an embodiment, a system for storing power and/or electrical power is connected to the network, and is controlled to deliver electricity to the network or to store electricity, generated by either of the generation sources, non-intermittent or intermittent, and not consumed by the at least one load.

According to an embodiment, the first time period is twenty-four hours.

According to an embodiment, the at least one source of non-intermittent generation comprises a power generator.

### BRIEF DESCRIPTION OF THE DRAWINGS

Other features and advantages will appear in the description that will follow of embodiments of the method for controlling the generation of electrical power in a network for generating and distributing electrical power, given as non-limitative examples, with reference to the attached drawings, in which:

FIG. 1 is a process diagram of the functioning of a network for generating and distributing electrical power according to the invention, the network comprising a non-intermittent generation source 101a, two intermittent generation sources 102a and 103a, a load 104 being connected to said network;

FIG. 2 is a process diagram of the steps of the method according to the invention.

### DETAILED DESCRIPTION OF PARTICULAR EMBODIMENTS

The present invention will now be described in the context of the microgrids, but can very well be extended to any type of network for generating and distributing electricity. Therefore, unless indicated otherwise, the term “microgrid” can just as well signify microgrid as network.

The present invention develops the concept of storage of electrical power. In fact, the predictions of consumption and generation of electrical power can be marred by an uncertainty, and thus lead to an imbalance between the power consumed and the power generated. The invention therefore proposes to put in place an immediately available store of electrical power making it possible to compensate for fluctuations of consumption and/or of generation of electrical power.

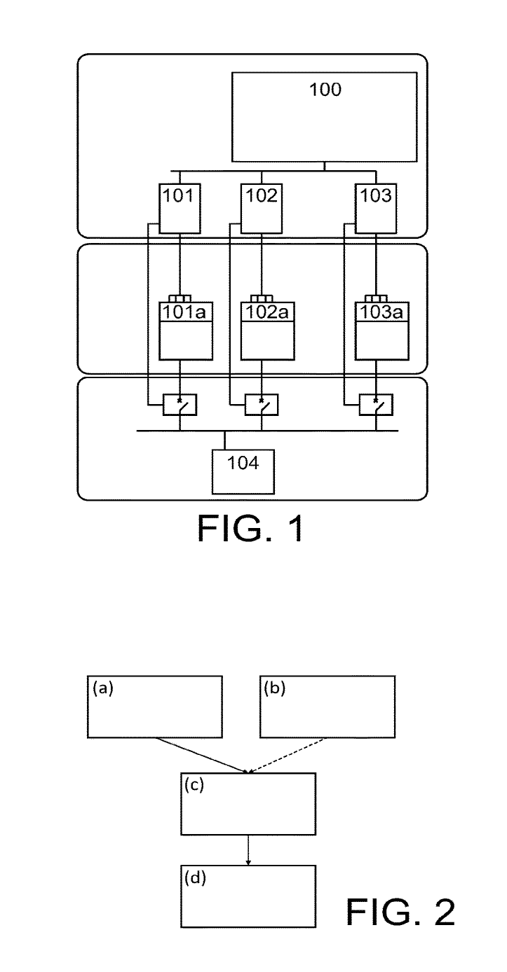

A method 100 for controlling the generation of electrical power in a network for generating and distributing electrical power will therefore be described with reference to FIGS. 1 and 2.

A microgrid generally comprises electricity generation sources. The electricity generation sources generate power and/or electrical power delivered to the microgrid as a voltage and as an alternating current of frequency f.

The electricity generation sources must include the non-intermittent generation sources 101a. Non-intermittent generation source 101a means controllable electricity generation sources.

The non-intermittent generation sources 101a in the context of the present invention consume a fuel in order to generate electricity, for example, fuel, fuel oil, gas.

A non-intermittent generation source 101a can therefore be a power generator.

The microgrid according to the invention thus comprises at least one non-intermittent generation source 101a.

The microgrid also comprises at least one intermittent generation source 102a, 103a. An intermittent power source is a source of power, non-controllable and/or dependent upon external parameters such as the meteorological conditions.

As an example, the renewable power sources are intermittent electricity generation sources.

A renewable power source can comprise photovoltaic panels, wind turbines, hydrokinetic turbines, thermodynamic machines.

At least one load 104 is connected to the microgrid. The at least one load 104 is intended to consume electricity delivered to the microgrid by the at least one non-intermittent generation source 101a and by the at least one intermittent generation source 102a, 103a.

More particularly, the quantity of electricity consumed by the at least one load 104 is the sum of a quantity of non-intermittent electricity and a quantity of intermittent electricity. The quantity of non-intermittent electricity and the quantity of intermittent electricity are generated, respectively, by the non-intermittent generation source 101a and by the intermittent generation source 102a, 103a.

The terms quantity of electricity and electrical power have the same meaning throughout the description, and will be identified as an electrical power.

Furthermore, consumption of electricity means consumption of electrical power.

The at least one load 104 of electricity can be industrial equipment, (for example, a factory and its machines), domestic equipment (for example, the domestic appliances equipping a home), urban furniture connected to the microgrid, electrical charging terminals etc.

The method 100 according to the invention, for controlling the generation of electrical power of the microgrid, comprises a step a. for predicting a demand for electrical power consumption by the at least one load 104, connected to the network, during a given first time period.

The first time period means a period starting at a first moment and terminating at a second moment, both fixed and predetermined. The first moment and the second moment can be fixed moments of the same day.

For example, the first time period can have a duration of twenty-four (24) hours.

The step a. of predicting the demand for electrical power consumption by the at least one load 104 can be based on a history of the consumption of electrical power of said at least one load 104.

For example, the prediction of the consumption of electrical power by the at least one load 104, during the next forthcoming first time period, can be equal to the actual consumption by said at least one load 104 during a past identical time period. The forthcoming next time period and the past identical time period, in the example given, start and terminate at the same moments of two different days.

Advantageously, the prediction of the demand for electrical power consumption by the at least one load 104 during the forthcoming first time period is equal to the electrical power consumed by said at least one load 104 forty-eight (48) or twenty-four (24) hours before the start of the first time period and for a duration equal to the first time period. The prediction of the consumption of electrical power by the at least one load 104, based on a historic consumption during the twenty-four or forty-eight hours preceding the start of the first time period therefore makes it possible to estimate, with a relatively good approximation, the electrical power that will be consumed by the at least one load 104 during the next first time period.

Still advantageously, the prediction of the demand for electrical power consumption by the at least one load 104 during the forthcoming first time period is equal to the electrical power consumed by said at least one load 104 during one day of a previous week, for example, the immediately previous week, or a week of the previous month, or a week of the previous year.

The prediction according to step a. can be refined by considering the meteorological forecasts. In fact, weather changes, occurring for example from one day to the next, can also have an influence on the consumption of electrical power by the loads 104 (for example, a decrease of temperatures can make it necessary to switch on heating systems, and consequently, to revise upwards the estimate of the demand for electrical power consumption by the at least one load 104). As soon as they are predictable, weather changes can therefore be used to refine the prediction of the demand for electrical power consumption by the at least one load 104.

The prediction according to step a. is marred however by a consumption uncertainty. In fact, the electrical power actually consumed can fluctuate around the prediction of electrical power consumption over an electrical power range determined by the consumption uncertainty.

Furthermore, the more the predictions are long-term, the greater the electrical power consumption uncertainty.

The uncertainty can be determined by means of historical electrical power consumption data. For example, by measuring the fluctuations in the demand for electrical power consumption over a given time period.

The method 100 according to the invention can also comprise a step b. of predicting a capacity for generating electrical power, during the first time period, of the at least one non-intermittent generation source 101a and of the at least one intermittent generation source 102a, 103a.

The prediction of the generation capacity is executed for each one of the electricity generation sources connected to the network. The prediction of electricity generation by an electricity generation source is therefore Eref.

The prediction of the generation capacity at step b. can be executed by considering a history of generation actually achieved by the at least one non-intermittent generation source 101a and by the at least one intermittent generation source 102a, 103a. The consideration of historical data is similar to what is described for the implementation of step a.

The prediction of the generation capacity at step b. can also be achieved by modelling, as mathematical equations, the capacity for generating electrical power of each of the at least one non-intermittent generation source 101a, and at least one intermittent generation source 102a, 103a as a function of physical parameters, the physical parameters being physical values influencing the capacity for generating electrical power of each of the at least one non-intermittent generation source 101a and at least one intermittent generation source. In this respect, the person skilled in the art may consult the document [1] mentioned at the end of the description.

Modelling, as a mathematical equation, the capacity for generating electrical power of each of the at least one non-intermittent generation source 101a, and at least one intermittent generation source 102a, 103a as a function of physical parameters is well known to the person skilled in the art and will therefore not be detailed in the description.

For example, the generation of electrical power by a power generator depends essentially on the nominal power of said generator, as well as the minimum and maximum powers that it can deliver. However, other parameters influence its capacity for generating electrical power, such as for example:
its state: operating or stopped,
its fuel reserve,
the length of the power lines (governing electrical losses) linking the power generator and the at least one load 104.

The list of these physical parameters is not exhaustive and can very well be completed by other parameters (for example, the time for conveying fuel, the consumption rate of said fuel by the power generator etc.).

The capacity for generating electrical power by a power generator can therefore be modelled as a mathematical equation taking account of the aforementioned physical parameters.

In an equivalent manner, the generating capacity of a renewable power source can also be modelled as a mathematical equation. The model can then take into account, for example:
the nominal power of the renewable power source,
sunlight or wind speed as a function of the type of renewable power source.

The knowledge of the meteorological forecasts and of the mathematical model governing the capacity for generating electrical power of the renewable power source therefore makes it possible to predict the quantity of electricity that will be generated by said source during the first time period. For example, energy E (in watt-hour) generated by a renewable power source of the photovoltaic panel type is obtained by the following relation: E=S*r*H*Cp.

Where S is the total surface area of the photovoltaic panels, r the output from the photovoltaic panels, H the sunlight, and Cp a coefficient of loss (generally less than 0.9).

The functioning of the power and/or energy storage system can also be modelled by a set of mathematical equations. However, it must be emphasized that a power and/or energy storage system is subject to aging as soon as it is subjected to loading and unloading cycles. This stress can be taken into account as a parameter influencing the functioning of said storage system. In fact, a storage system represents a significant investment, and it may sometimes be preferable to switch on a power generator to supply the electricity rather than impose a loading/unloading cycle on a storage system.

However, whatever the method employed to execute step b., the prediction of the capacity for generating electrical power, during the first time period, is also marred by a generation uncertainty. In fact, the electrical power actually generated can fluctuate around the prediction of electrical power generation over an electrical power range determined by the generation uncertainty. The generation of electricity from each of the sources can therefore be situated between a minimum electrical power (Emin) and a maximum electrical power (Emax). The values Emin and Emax are understood to be different for each electricity generation source.

Furthermore, the more the predictions are long-term, the greater the electrical power generation uncertainty.

The method 100 according to the invention also comprises a step c. of distributing, during the first time period, an electrical power to be generated between the at least one non-intermittent generation source 101a and the at least one intermittent generation source 102a, 103a.

The electrical power to be generated is equal to the prediction of step a. such that there is balance between the electrical power generated (by the at least one non-intermittent and intermittent generation source) and the electrical power consumed, according to the prediction, by the at least one load 104.

The distributing step is also suitable for minimizing a fuel consumption required for the generation of electrical power to be generated by the at least one non-intermittent generation source 101a and the at least one intermittent generation source 102a, 103a.

The prediction of the capacity for generating electricity by a renewable power source can also allow the best possible adjustment of the generation of electricity by the at least one non-intermittent generation source 101a, and thereby the optimisation (minimization) of the consumption of fuel by the at least one non-intermittent generation source 101a.

However, the fluctuations of consumption of electrical power and of generation of electrical power can lead to an imbalance between generation and consumption of electrical power.

In a first specific case, there can be an excess of electrical power. It is then possible, for example, to adjust the level of generation of the at least one renewable power source. For example, the power output by a photovoltaic cell can be adjusted with a Maximum Power Point Tracker (MPP), such that there is no excess of electrical power on the network. It is also possible to provide the network with a system for storing electrical power suitable for storing any surplus generation of electrical power. It is also possible to reduce the generation of electrical power of the at least one non-intermittent generation source 101a.

In a second specific case, the power generated is deficient compared with the electrical power actually consumed. A power reserve must therefore be immediately available in order to restore the balance between the consumption and the generation of electrical power.

In the two aforementioned specific cases, the balance is considered to have been restored by a reserve, negative in the first specific case and positive in the second specific case.

The method according to the invention therefore comprises a step d. of dimensioning a reserve of electrical power, immediately available during the first time period, the dimensioning being suitable for compensating, at least in part, for the consumption uncertainty.

The dimensioning of the reserve of electrical power can also be adjusted to compensate, at least in part, for the generation uncertainty once step c. has been executed.

Compensating, at least in part, for the consumption and/or the generation uncertainty, means restoring, at least in part, the balance between consumption and generation of electrical power.

Dimensioning of a reserve means reserving at least a part of the generating capacity of at least one non-intermittent generation source, this part being intended to be delivered immediately to the network to compensate for fluctuations of consumption and/or generation of electrical power that are due to consumption and generation uncertainties. In a complementary manner, the reserve role can be played by a power storage system.

A temporary decrease (fluctuation) of electricity generation by the at least one renewable power source will therefore not necessarily result in starting up an additional non-intermittent generation source 101a (for example, a power generator). It will be possible to compensate for the temporary decrease in the generation of electricity, for example by the reserve dimensioned at step d. For example, a system for storing electrical power that is connected to the network can deliver electricity to the network or store the electricity generated by either of the generation sources, non-intermittent or intermittent, and not consumed by the at least one load 104.

A temporary decrease of electricity generation can for example be observed when a small cloud temporarily shields a photovoltaic generation source.

In accordance with the methods known in the prior art for managing a network for generating and distributing electricity, as soon as a decrease in the generation of electricity by intermittent power sources (renewable, for example) is observed, a power generator is started up, whether the decrease is temporary or long-lasting.

Contrary to a temporary decrease (sudden presence of a cloud in front of photovoltaic panels, for example), in the majority of cases, a long-lasting decrease has a forecast character and can consequently be anticipated.

A long-lasting decrease corresponds for example to meteorological conditions unfavourable to the generation of electrical power by an intermittent power source (renewable, for example). Said unfavourable meteorological conditions are generally predictable, and the generation deficit of an intermittent power source can be compensated for by another electrical power generation source, for example a non-intermittent generation source (a power generator, for example).

Knowledge of the predictions of step a. and potentially of step b. therefore make it possible, at step c., to distribute the generation of electrical power between the at least one non-intermittent generation source 101a and the at least one intermittent generation source 102a, 103a during the first time period.

Putting in place a reserve according to the invention makes it possible to compensate for fluctuations of consumption and generation of electrical power.

The distribution can generally be executed in accordance with the criteria for minimizing the costs of power generation.

For example, in a first approach, the method 100 according to the invention will seek to minimize the fuel consumption.

Advantageously, the control method 100 is executed twenty-four hours before the start of the first time period. Furthermore, in order to refine the predictions, the control method 100 can be executed at regularly spaced time intervals so as to take account of a change to the prediction, according to step b., of the capacity for generating electrical power of the at least one non-intermittent generation source 101a and of the at least one intermittent generation source. The method 100 can for example be executed every 30 or 15 minutes.

The method 100 according to the invention can advantageously be executed by a computer or a PC.

The output data of the method according to the invention comprises an electrical power to be supplied by each type of generation source during the first time period. The values Eref, Emin and Emax are also supplied for each of the electrical power generation sources, intermittent and non-intermittent.

The predictions of the steps a. and b. therefore make it possible to establish a load plan (namely a quantity of electrical power to be generated by each of the electrical power generation sources, intermittent and non-intermittent). The reserve, ensured by at least one non-intermittent generation source, makes it possible to compensate for the fluctuations of consumption and/or generation of electrical power.

The method 100 according to the invention can therefore be implemented on a pre-existing network without necessitating any major change of said network.

In the context of a microgrid (such as defined in the prior art part), the method according to the invention constitutes a higher layer of control of the microgrid. In other words, the method provides an additional level of control enabling controllers 101, 102, 103 (on FIG. 1) to control the generation of electricity at the sources 101a, 102a and 103a.

However, as soon as a long-lasting, and unpredicted decrease in the electrical power generation of a renewable power source is observed, the controller 102 of the power plants can decide to compensate for said decrease by increasing the generation of electrical power by the power generators that it controls. It may, for example, decide to start up an additional power generator.

### REFERENCE

[1]: Adel Mellit, Alessandro Massi Pavan, “A 24-h forecast of solar irradiance using artificial neural network: Application for performance prediction of a grid-connected PV plant at Trieste, Italy”, Solar Energy, Volume 84, Issue 5, May 2010, Pages 807-821, ISSN 0038-092X.

1. A method for controlling the generation of electrical power in a network for generating and distributing electrical power, the network comprising at least one non-intermittent generation source and at least one intermittent generation source, the method comprising:
a. a step of predicting a demand for consumption of electrical power by at least one load, connected to the network, during a given first time period, said prediction of the demand for consumption being determined with a consumption uncertainty;
c. a step of distributing, during the first time period, between the at least one non-intermittent generation source and the at least one intermittent generation source of an electrical power to be generated, the electrical power to be generated fulfilling the demand for consumption predicted at step a., the distributing step being suitable for minimizing a fuel consumption required for the generation of the electrical power to be generated by the at least one non-intermittent generation source and the at least one intermittent generation source; and
a step d. of dimensioning a reserve of electrical power immediately available during the first time period, the dimensioning being suitable for compensating, at least in part, for the consumption uncertainty and/or the generation uncertainty.

2. The method according to claim 1, wherein the reserve of electrical power is ensured by a non-intermittent generation source chosen between the at least one non-intermittent generation source (101a) and/or a power storage system also connected to the network.

3. The method according to claim 1, wherein the method furthermore comprises a step b. of predicting a capacity for generating electrical power, during the first time period, of the at least one non-intermittent generation source and of the at least one intermittent generation source, said predicting being determined with a generation uncertainty; the step d. being suitable for the reserve of electrical power to compensate also for the generation uncertainty.

4. The method according to claim 3, wherein the step b. comprises modelling, as mathematical equations, the capacity for generating electrical power of each of the at least one non-intermittent generation source and at least one intermittent generation source as a function of physical parameters, the physical parameters being physical values influencing the capacity for generating electrical power of each of the at least one non-intermittent generation source and at least one intermittent generation source.

5. The method according to claim 4, wherein the physical parameters influencing the capacity for generating electrical power of the at least one intermittent generation source (comprise the meteorological forecasts during the first time period, the sunlight and/or wind speed during the first time period.

6. The method according to claim 3, wherein the control method is executed twenty-four hours before the start of the first period, the optimisation method is executed at regularly spaced time intervals so as to take account of a change of the prediction, according to step b., of the capacity for generating electrical power of the at least one non-intermittent generation source and of the at least one intermittent generation source.

7. The method according to claim 3, wherein an additional non-intermittent generation source is started up as soon as the dimensioning of the reserve of electrical power immediately available during the first time period is insufficient to compensate, at least in part, for the consumption and/or generation uncertainty.

8. The method according to claim 1, wherein the step a. of predicting the demand for consumption of electrical power by the at least one load during a first time period is equal to an electrical power consumed by said at least one load forty-eight hours before the start of the given first time period, and for a duration equal to the first time period.

9. The method according to claim 1, wherein the at least one intermittent generation source is a renewable power generation source, the renewable power generation source comprises at least one source selected between: a photovoltaic source of electricity, a wind turbine source of electricity.

10. The method according to claim 1, wherein a system for storing power and/or electrical power is connected to the network, and is controlled to deliver electricity to the network or to store electricity generated by either of the generation sources, non-intermittent or intermittent, and not consumed by the at least one load.

11. The method according to claim 1, wherein the first time period is twenty-four hours.

12. The method according to claim 1, wherein the at least one non-intermittent generation source comprises a power generator.
